(19) United States
(12) Patent Application Publication
(10) Pub. No.: US 2004/0008428 A1
(43) Pub. Date: Jan. 15, 2004

(54) Structure of non-circular lens holder

(76) Inventors: Po-Hua Fang, Yung-Ho City (TW); Shu-Ya Chiang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/191,527

(22) Filed: Jul. 10, 2002

(51) Int. Cl. G02B 7/02

(52) U.S. Cl. 359/819

(57) ABSTRACT

A non-circular lens holder is disclosed in this present invention. The above-mentioned non-circular lens holder can efficiently hold a non-circular lens therein by the special structure of the non-circular lens. Furthermore, because the non-circular lens may by smaller than an original circle lens, the non-circular lens holder can save more space than the circle lens holder in the prior art. Hence, this invention can provide a non-circular lens holder for holding a non-circular lens efficiently, and the space occupied by the lens holder in a photographic device can be saved.

### BACKGROUND OF THE INVENTION

1. Field of the Invention

This present invention relates to a lens holder, and more particularly, to a non-circular lens holder.

2. Description of the Prior Art

Lens is an important element in a photographic device. In the case of a scanner, referred to in FIG. 1, the light reflected from a document 100 will be across a lens 120, and then achieve a charge coupled device (CCD) 140. In the prior art, the lens is usually produced in a circle-formed. However, as shown in FIG. 1, only the portion in the X-direction in the vicinity of the center of the circle lens is utilized for capturing image. In other words, not all of the original circle lens will be used during the image capturing of the photographic device. Hence, if the volume of the lens in a photographic device is reduced and the reduced lens will not influence the function of the lens, the space in the photographic device can be saved efficiently.

Hence, for saving the space in a photographic device and holding the non-circular lens efficiently, it is an important object to provide a non-circular lens holder for holding a non-circular lens therein.

### SUMMARY OF THE INVENTION

In accordance with the present invention, a non-circular lens holder is provided for holding a non-circular lens of a photographic device, so that the non-circular lens holder can hold the non-circular lens efficiently.

It is another object of this invention to save the space in a photographic device by utilizing a non-circular lens holder to hold a non-circular lens in the photographic device.

In accordance with the above-mentioned objects, the invention provides a structure of a non-circular lens holder in a photographic device. According to this prevent invention, a non-circular lens holder is employed to hold a non-circular lens in a photographic device. The above-mentioned non-circular lens holder can efficiently hold a non-circular lens in a photographic device by the special structure of the non-circular lens holder. Moreover, because the non-circular lens may be smaller than the original circle lens, the non-circular lens holder and the non-circular lens therein according to this invention can save more space in a photographic device than the circle lens holder and the circle lens therein in the prior art. Therefore, according to this invention, it is efficiently for holding a non-circular lens in a photographic device by the above-mentioned non-circular lens holder, and saving the space in the photographic device by the non-circular lens holder disclosed in this application.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a diagram showing the displacement of a lens in a photographic device;

FIG. 2A depicts a structure of a non-circular lens holder according to this presented invention; and

FIG. 2B depicts another structure of a non-circular lens holder according to this presented invention;

FIG. 2C depicts another structure of a non-circular lens holder according to this presented invention;

FIG. 2D depicts another structure of a non-circular lens holder according to this presented invention;

FIG. 3 depicts another structure of a non-circular lens according to this present invention.

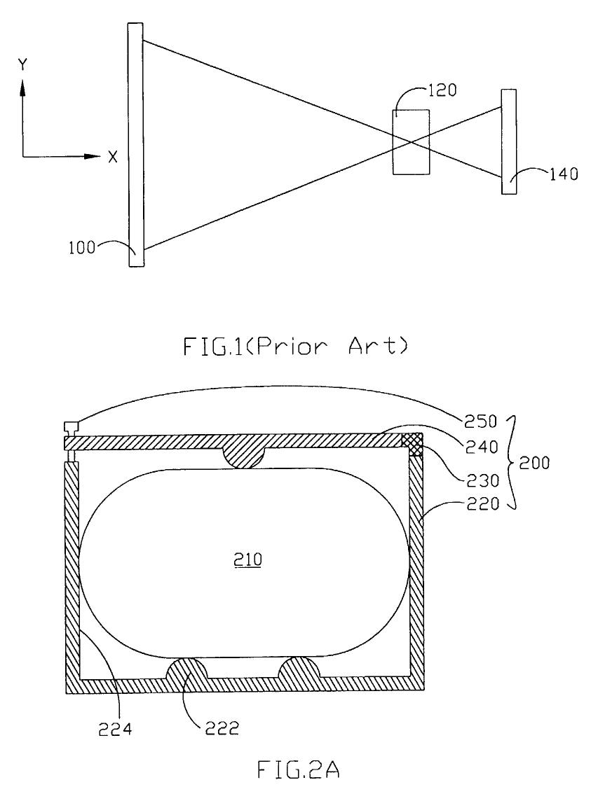

### DESCRIPTION OF THE PREFERRED EMBODIMENTS

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

Then, the components of the devices in this application are not shown to scale. Some dimensions are exaggerated to the related components to provide a more clear description and comprehension of the present invention.

One preferred embodiment of this invention is about a holder of a non-circular lens. The above-mentioned non-circular lens holder comprises a bottom cover, and a top cover with an end connected to the bottom cover. A room for disposing a non-circular lens therein is formed between the bottom cover and the top cover. The bottom cover and the top cover comprise at least a fastening element on the inside surfaces of the bottom cover and the top cover. The fastening element can hold the non-circular lens by the topography of the fastening element. The fastening element comprises at least a protruding portion, a curved part, a flat part, or other geometrical patterns. The above-mentioned protruding part, the curved part, and the flat part are employed for holding the non-circular lens. For example, the protruding part or the flat plane may be utilized for holding the non-circular lens on the curved surface of the non-circular lens, and the protruding part or the curved part of the above-mentioned holder may be employed for holding the flat surface of the non-circular lens.

In the above-mentioned non-circular lens holder, both the bottom cover and the top cover may be consisted of metal, plastic, or the other rigid materials. The end of the top cover attaching to the bottom cover may be thin in the thickness, and thus the other end of the top cover has enough elasticity for attaching and leaving the bottom cover. The above-mentioned holder further comprises a connecting element for attaching the other end (the free end) of the top cover to the bottom cover. The connecting element may be a pin, a screw, or other fixing means.

In the manufacturing of a lens holder, it is easier to form the protruding parts in the same thickness than to form a flat part with every part in the same thickness. Therefore, the lens held by the lens holder according to this embodiment will not be tilted by the lens holder in the prior art, wherein the lens holder in the prior art employs the flat surfaces to hold a lens. Moreover, before the marketing of the lens and the lens holder, the lens is suffered to an adjusting process to make sure the disposition of the lens in the lens holder. In this present embodiment, because the touch areas between the lens and the lens holder are very small, the above-mentioned adjustment of the lens can be easily performed before attaching the top cover to the bottom cover with the connecting element.

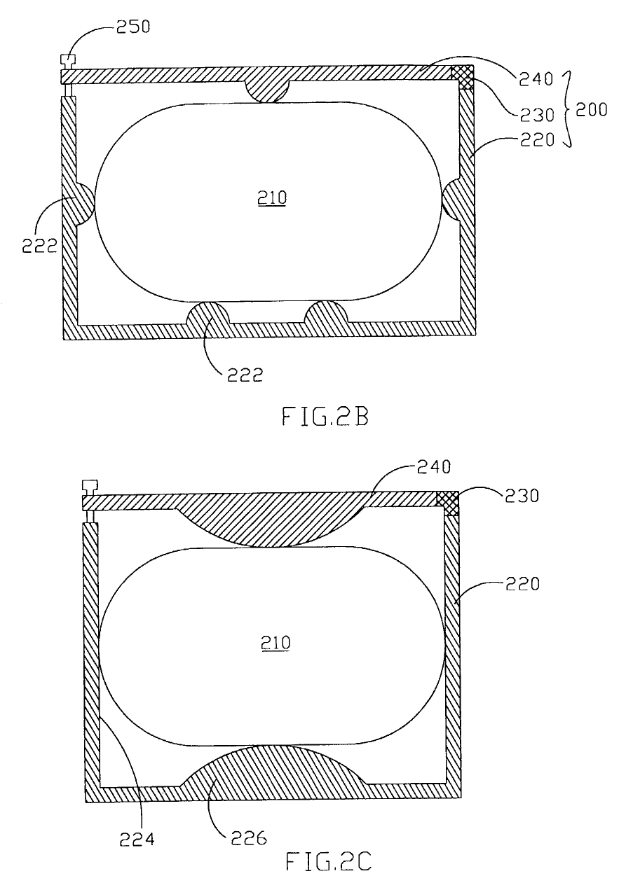

Another preferred embodiment of this present invention is about a non-circular lens holder. FIG. 2A depicts a non-circular lens holder 200 according to this embodiment and a non-circular lens 210 therein. The non-circular lens holder 200 comprises a bottom cover 220, and a top cover 240. The bottom cover 220 may be formed in a U-shaped, as shown in FIG. 2A. The bottom cover 220 and the top cover 240 are consisted of plastic, metal, or other materials. The above-mentioned non-circular lens holder 200 further comprises a connecting element 250 for fastening the top cover 240 to the bottom cover 220. The connecting element 250 may be a screw, a pin, or other fixing means.

An end of the top cover 240 is connected to the bottom cover 220 at the junction 230. The junction 230 may comprise a roller, or the like element. Thus, the above-mentioned end of the top cover 240 is fixed on the bottom cover 220, and another end of the top cover 240 can be moved near the bottom cover 220. In another case, the top cover 240 and the bottom cover 220 may be originally connected each other. The junction 230 means the part between the top cover 240 and the bottom cover 220. The thickness of the junction 230 may be very thin, and thus the junction 230 has enough elastic for removing another end of the top cover 240 to dispose a non-circular lens 210 into the non-circular lens holder 200.

The non-circular lens holder 200 further comprises at least a protruding part on the inside surfaces of the bottom cover 220 or the top cover 240. The non-circular lens holder 200 may further comprise at least a flat part or at least a curved part on the inside surfaces of the bottom cover 220 or the top cover 240. The protruding part or the flat part may be employed for holding the non-circular lens on the curved surface of the non-circular lens. The protruding part or the curved part may be employed for holding the non-circular lens on the flat surface of the non-circular lens. For instance, referred to FIG. 2A, the bottom cover 220 and the top cover 240 may use a plurality of protruding part 222 to hold the flat surface of the non-circular lens 210. Moreover, the bottom cover 220 employs the flat parts 224 to hold the curved surface of the non-circular lens 210.

In another case, the non-circular lens 200 may comprises a plurality of protruding part 222 on the inside surfaces of the top cover 240 and the bottom cover 220, as shown in FIG. 2B. The protruding portions 222 can be used to hold a non-circular lens 210 on the curved surface and the flat surface of the non-circular lens 210, respectively.

In another case according to this embodiment, the non-circular lens 200 comprises at least a flat part 224 and at least a curved part 226 on the inside surfaces of the top cover 240 and the bottom cover 220, as shown in FIG. 2C. The flat part 224 can be used to hold a non-circular lens 210 on the curved surface of the non-circular lens 210. The curved part 226 can be used to hold a non-circular lens 210 on the flat surface of the non-circular lens 210.

In still another case according to this embodiment, the non-circular lens 200 comprises at least a protruding part 222 and at least a curved part 226 on the inside surfaces of the top cover 240 and the bottom cover 220, as shown in FIG. 2D. The protruding part 222 can be used to hold a non-circular lens 210 on the curved surface of the non-circular lens 210. The curved part 226 can be used to hold a non-circular lens 210 on the flat surface of the non-circular lens 210.

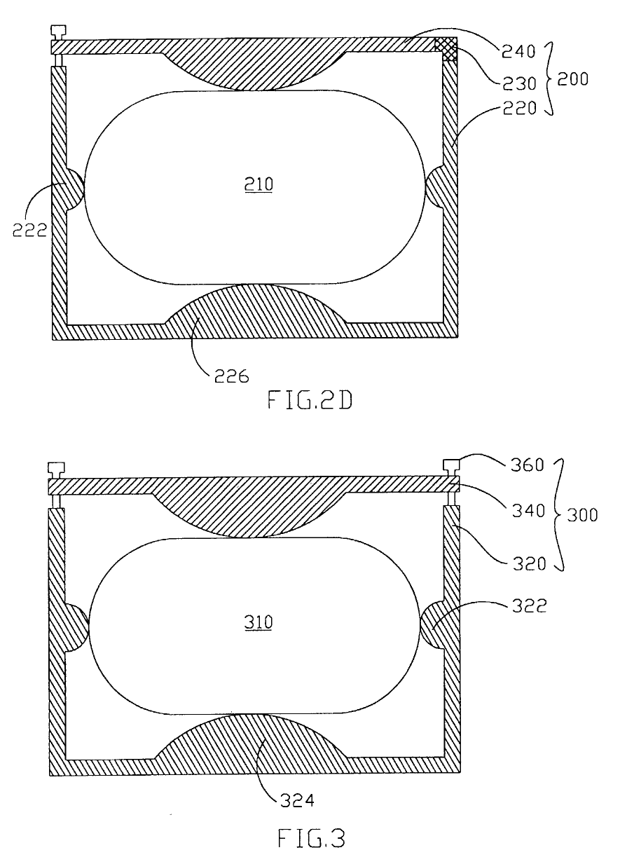

Another preferred embodiment according to this present invention is a non-circular lens holder. In FIG. 3, a non-circular lens holder 300 according to this present embodiment is described. The above-mentioned non-circular lens holder 300 comprises a bottom cover 320, and a top cover 340. A non-circular lens 310 can be disposed into the room between the bottom cover 320 and the top cover 340. The bottom cover 320 and the top cover 340 may be consisted of plastic, metal, or other rigid materials. The non-circular lens holder 300 further comprises at least two, connecting elements 350 for fastening the top cover 340 to the bottom cover 320. The above-mentioned connecting element 350 may be a screw, a pin, a bolt, or other fixing means, wherein the fixing means can be utilized for fastening the top cover 340 to the bottom cover 320.

The non-circular lens holder 300 further comprises at least a protruding part on the inside surfaces of the bottom cover 320 or the top cover 340. The non-circular lens holder 300 may further comprise at least a curved part or at least a flat part on the inside surfaces of the bottom cover 320 or the top cover 340. For example, referred to FIG. 3, the bottom cover 320 comprises a plurality of protruding part 322 on the inside surface of the bottom cover 320, and the protruding parts are employed for holding the curved surface of the non-circular lens 310. The bottom cover 320 and the top cover 340 comprise the curved parts 324 on the inside surfaces of the bottom cover 320 and the top cover 340 for holding the non-circular lens 310 on the flat surface of the non-circular lens 310. Generally, in this present invention, the protruding parts or the flat parts are employed for holding the non-circular lens on the curved surfaces of the non-circular lens. Moreover, the protruding parts or the curved parts of the lens holder according to this embodiment are utilized for holding the non-circular lens on the flat surfaces of the non-circular lens.

In another case, the non-circular lens 300 may comprises a plurality of protruding part on the inside surfaces of the top cover 340 and the bottom cover 320. The protruding portions can be used to hold a non-circular lens 310 on the curved surface and the flat surface of the non-circular lens 310, respectively.

In another case according to this embodiment, the non-circular lens 300 comprises at least a flat part and at least a curved part on the inside surfaces of the top cover 340 and the bottom cover 320. The flat part can be used to hold a non-circular lens 310 on the curved surface of the non-circular lens 310. The curved part can be used to hold a non-circular lens 310 on the flat surface of the non-circular lens 310.

In still another case according to this embodiment, the non-circular lens 300 comprises at least a protruding part and at least a flat part on the inside surfaces of the top cover 340 and the bottom cover 320. The protruding part can be used to hold a non-circular lens 310 on the flat surface of the non-circular lens 310. The flat part can be used to hold a non-circular lens 310 on the curved surface of the non-circular lens 310.

In this manner, the contact areas between the non-circular lens holder 300 and the non-circular lens 310 are very small. Thus, while the non-circular lens 310 is suffered an adjusting process before marketing, the above-mentioned adjustment is performed easily. Furthermore, comparing with the circle lens in the prior art, the above-mentioned non-circular lens 310 is smaller than the original circle lens, and the non-circular lens holder 300 may occupy less space of a photographic device than the original circle lens holder. In other words, the non-circular lens holder according to this present invention can save the space of a photographic device, such as the space in the chassis of a scanner.

According to the preferred embodiments, this invention discloses a non-circular lens holder. In this present invention, the non-circular lens holder comprises a bottom cover, and a top cover. One end of the top cover is attached to the bottom cover by a connecting element. The other end of the top cover may be connected to the bottom cover at a junction, or attached to the bottom cover by another connecting element. The above-mentioned non-circular lens holder further comprises at least a protruding part on the inside surface of the top cover or the bottom cover. The non-circular lens holder may further comprise at least a flat part or at least a curved part on the inside surface of the top cover or the bottom cover. Generally, the protruding parts or the flat parts are employed for holding the curved surfaces of the non-circular lens. The protruding parts or the curved parts are employed for holding the flat surfaces of the non-circular lens. Hence, the non-circular lens holder according to this present invention can efficiently hold a non-circular lens. Moreover, in this invention, because a non-circular lens may be smaller than an original lens, the non-circular lens holder according to this invention will occupy less space in a photographic device than the original circle lens holder. Therefore, the lens holder according to this present invention can not only efficiently hold a non-circular lens in a photographic device, but also save the space in the photographic device.

Although specific embodiments have been illustrated and described, it will be obvious to those skilled in the art that various modifications may be made without departing from what is intended to be limited solely by the appended claims.

What is claimed is:

1. A structure of a non-circular lens holder, comprising:
a bottom cover;
a top cover;
at least a fastening element on an inside surface of said bottom cover or said top cover; and
at least a connecting element for attaching said top cover to said bottom cover.

2. The structure according to claim 1, wherein said fastening element comprises at least a protruding part on an inside surface of said top cover.

3. The structure according to claim 1, wherein said fastening element comprises a protruding part on an inside surface of said bottom cover.

4. The structure according to claim 1, wherein said fastening element comprises at least a flat part on an inside surface of said bottom cover.

5. The structure according to claim 1, wherein said fastening element comprises at least a flat part on an inside surface of said top cover.

6. The structure according to claim 1, wherein said fastening element comprises a curved part on an inside surface of said bottom cover.

7. The structure according to claim 1, wherein said fastening element comprises a curved part on an side surface of said top cover.

8. The structure according to claim 1, wherein said top cover comprises a junction for connecting one end of said top cover to said bottom cover.

9. The structure according to claim 8, wherein said junction is elastic.

10. A structure of a non-circular lens holder, comprising:
a bottom cover;
a top cover with a end connecting to said bottom cover;
at least a fastening element on an inside surface of said bottom cover or said top cover; and
a connecting element for attaching another end of said top cover to said bottom cover.

11. The structure according to claim 10, wherein said fastening element comprises at least a flat part on an inside surface of said bottom cover or said top cover.

12. The structure according to claim 10, wherein said fastening element comprises at least a curved part on an inside surface of said bottom cover or said top cover.

13. The structure according to claim 10,wherein said fastening element comprises at least a protruding part on an inside surface of said bottom cover and said top cover.

14. The structure according to claim 10, wherein said end of said top cover connecting to said bottom cover comprises a junction.

15. The structure according to claim 10, wherein said connecting element is a screw.

16. A structure of a non-circular lens holder, comprising:
a bottom cover;
a junction connected to said bottom cover;
a top cover with a end connected to said junction;
at least a protruding part on an inside surface of said non-circular lens holder; and
at least a connecting element for attaching said top cover to said bottom cover.

17. The structure according to claim 16, further comprises at least a curved part on an inside surface of said bottom cover or said top cover.

18. The structure according to claim 16, further comprises at least a flat part on an inside surface of said bottom cover or said top cover.

19. The structure according to claim 16, wherein one end of said top cover is connected to said bottom cover.

20. The structure according to claim 16, wherein said connecting element is a screw.
